(19) United States
(12) Patent Application Publication
(10) Pub. No.: US 2013/0308080 A1
(43) Pub. Date: Nov. 21, 2013

(54) Optical Film for LCD Device and LCD Device

(71) Applicants: Yicheng Kuo, Shenzhen (CN); Shihhsiang Chen, Shenzhen (CN); Gege Zhou, Shenzhen (CN)

(72) Inventors: Yicheng Kuo, Shenzhen (CN); Shihhsiang Chen, Shenzhen (CN); Gege Zhou, Shenzhen (CN)

(21) Appl. No.: 13/515,596

(22) PCT Filed: May 16, 2012
(86) PCT No.: PCT/CN12/75596

§ 371 Date: Jun. 13, 2012

(51) Int. Cl. G02F 1/1333; G02B 26/02

(52) U.S. Cl. 349/110; 359/237

(57) ABSTRACT

The invention provides an optical film for an LCD device and an LCD device. The optical film includes a display area in a middle part and a non-display area in an edge part; the non-display area is provided with a light shading layer. The inventor finds that the non-display area of the optical film just covers a surface of the middle frame; thus, the light shading layer is directly arranged in the non-display area of the optical film, to prevent the middle frame from leaking light in a joining position. In addition, the invention uses the existing material to achieve the light shading capability of the middle frame, thereby having the advantages of simplicity, practicality, and low cost.

### TECHNICAL FIELD

The invention relates to the field of liquid crystal displays (LCDs), and more particularly to an optical film for an LCD device and an LCD device.

### BACKGROUND

An LCD device generally includes a front frame and a middle frame from outside to inside; a light guide panel (LGP) is circumferentially fixed in the middle frame, and an optical film is arranged on a surface of the light guide panel. In a design of a conventional LCD module, the middle frame is generally made of an integrated member or a quartered member, thereby requiring making different moulds to meet the requirement of the different sizes of moulds. Thus, the development cost cannot be reduced, and the development time cannot be shortened.

If a segmented design is used to the middle frame, namely the function of the middle frame is achieved by combining the segmented members, but a light leakage is generated via a gap between the segmented members, thereby reducing the optical quality.

### SUMMARY

In view of the above-described problems, the aim of the invention is to provide an optical film for an LCD device and an LCD device capable of preventing a middle frame from leaking light.

The aim of the invention is achieved by the following technical scheme.

An optical film for an LCD device, the optical film comprises a display area in a middle part and a non-display area in an edge part; the non-display area is provided with a light shading layer.

Preferably, the light shading layer is arranged in a joining position of a middle frame of the LCD device. Because the phenomenon of light leakage in the joining position is the most serious, the cost can be reduced when the light shading layer is purposefully arranged in the joining position.

Preferably, the light shading layer is arranged to surround the whole edge of the optical film, and covers the whole non-display area. Thus, a surface of the middle frame can be covered to a maximum extent, and the prevention capability of light leakage is high.

Preferably, the optical film comprises a plurality of layers; a surface of the non-display area of one of layers is provided with the light shading layer. The optical film can employ a plurality of layers, and only one of layers is required to be provided with the light shading layer, thereby favoring to simplify the production process, and to save the cost.

Preferably, the surface of the non-display area of the optical film is covered with an ink layer, to form the light shading layer. This is a specific material of the light shading layer. The ink has the advantages of good light shading effect, strong adhesive capacity, and convenient processing.

An LCD device comprises an optical film; the optical film comprises a display area in a middle part and a non-display area in an edge part; the non-display area is provided with a light shading layer in a light leakage position of the LCD device.

Preferably, the LCD device further comprises a middle frame; a surface of the middle frame is covered with the optical film; the middle frame is formed by joining a plurality of middle frame structure units, and the light shading layer is at least arranged in a joining position of the middle frame structure units of the non-display area of the optical film. This is the LCD device with a joined middle frame.

Preferably, the middle frame is formed by joining a plurality of frame edge units and four frame corner units, and the non-display area of the optical film is provided with the light shading layer in the joining position of the middle frame structure units. This is one specific joining mode of the middle frame. Because the phenomenon of light leakage in the joining position of the middle frame is the most serious, the cost can be reduced when the light shading layer is purposefully arranged in the joining position.

Preferably, the middle frame is formed by joining a plurality of frame edge units, and the non-display area of the optical film is correspondingly provided the light shading layer in the joining positions between the middle frame structure units and four corner positions of the middle frame. This is another specific joining mode of the middle frame. Because the phenomenon of light leakage in the joining position of the middle frame is the most serious, the cost can be reduced when the light shading layer is purposefully arranged in the joining position.

Preferably, the light shading layer is arranged to surround the whole edge of the optical film, and covers the whole non-display area. Thus, a surface of the middle frame can be covered to a maximum extent, and the prevention capability of light leakage is high.

The inventor finds that the non-display area of the optical film just covers the surface of the middle frame; thus, the light shading layer is directly arranged in the non-display area of the optical film, to prevent the middle frame from leaking light in the joining position. In addition, the invention uses the existing material to achieve the light shading capability of the middle frame, thereby having the advantages of simplicity, practicality, and low cost.

### BRIEF DESCRIPTION OF FIGURES

FIG. 1 is a schematic diagram of an optical film of the invention;

FIG. 2 is a schematic diagram of an optical film covered with a light shading layer on the whole surface edge of the invention;

FIG. 3 is a schematic diagram of a light shading layer covering a joining position of a first example of the invention;

FIG. 4 is a schematic diagram of a light shading layer covering the whole surface of a middle frame of a first example of the invention;

FIG. 5 is a schematic diagram of a light shading layer covering a joining position of a second example of the invention; and

FIG. 6 is a schematic diagram of a light shading layer covering the whole surface of a middle frame of a second example of the invention.

Legends: 100. middle frame; 110. frame corner unit; 120. frame edge unit; 200. optical film; 210. light shading layer.

### DETAILED DESCRIPTION

The invention will further be described in detail in accordance with the figures and the preferable examples.

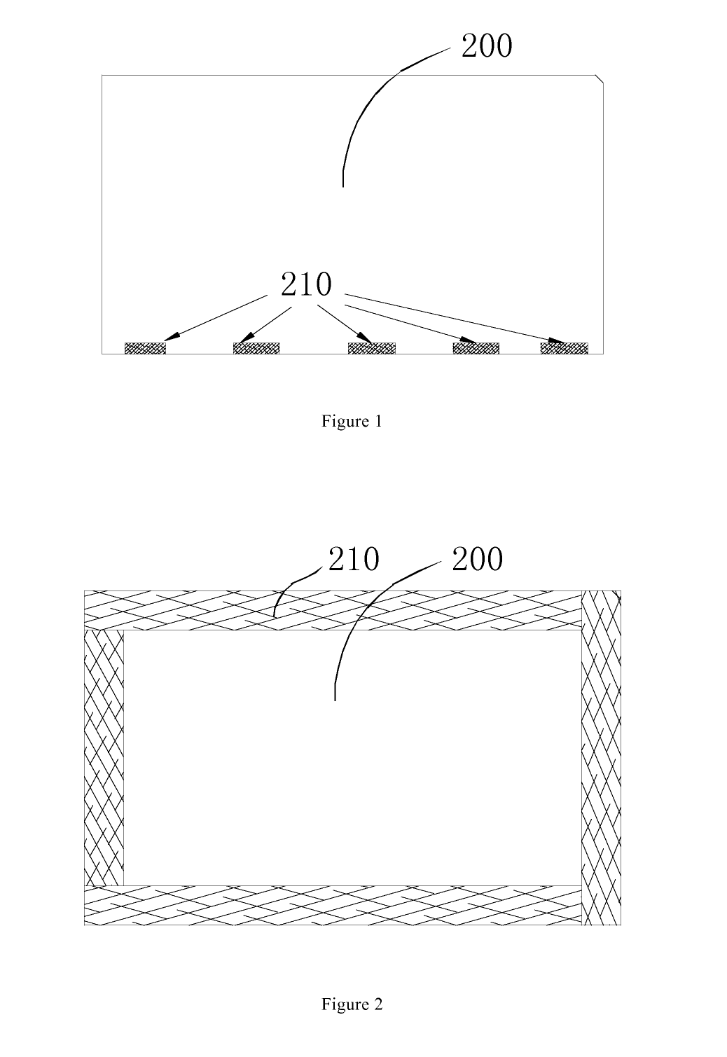

An LCD device comprises a backlight module and an LCD panel; a light emitting surface of the backlight module is provided with an optical film. As shown in FIGS. 1 and 2, the optical film comprises a display area in a middle part and a non-display area in an edge part; the non-display area is provided with a light shading layer in a light leakage position of the LCD device. Because the optical film is positioned on the light emitting surface of the backlight module, the light shading capability can be achieve whether the LCD device is provided with a middle frame nor not. However, the middle frame is generally arranged in the LCD device, which is provided with a joined middle frame is used as an example in the example. The LCD device comprises a middle frame; a surface of the middle frame is covered with an optical film, and the middle frame is formed by joining a plurality of middle frame structure units. The optical film comprises a display area in a middle part, and a non-display area in an edge part; the non-display area is provided with a light shading layer (as shown in FIGS. 1 and 2).

The inventor finds that the non-display area of the optical film just covers the surface of the middle frame; thus, the light shading layer is directly arranged in the non-display area of the optical film, to prevent the middle frame from leaking light in a joining position. In addition, the invention uses the existing material to achieve the light shading capability of the middle frame, thereby having the advantages of simplicity, practicality, and low cost. The invention will further be described in detail in accordance with the LCD devices with different types of the joined middle frames.

### Example 1

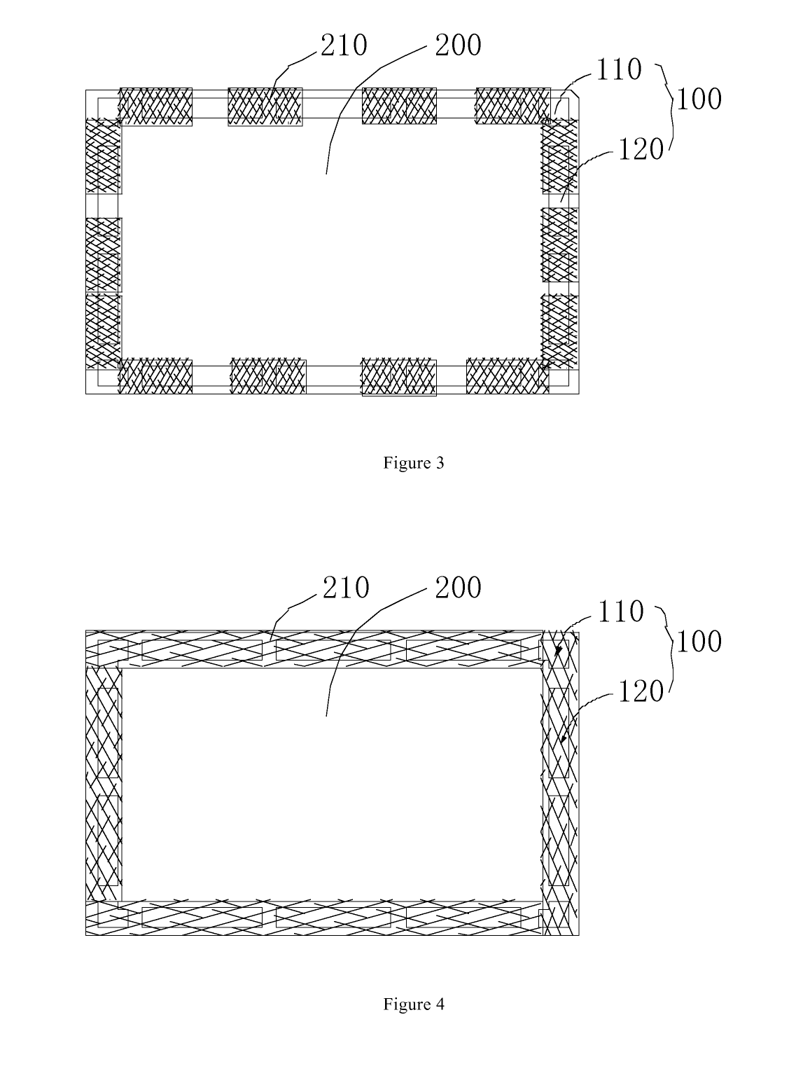

As shown in FIG. 3, an LCD device comprises a middle frame 100; a surface of the middle frame 100 is covered with an optical film 200. The middle frame 100 is formed by joining a plurality of frame edge units 120 and four frame corner units 110, and a non-display area of the optical film 200 is provided with a light shading layer 210 in a joining position of the middle frame structure units. The optical film 200 can be of a single-layer structure, and can also be of a multiple-layer structure. For the optical film of the multiple-layer structure, only a surface of one of layers is required to be provided with the light shading layer. Because the phenomenon of light leakage in the joining position of the middle frame 100 is the most serious, the cost can be reduced when the light shading layer 210 is purposefully arranged in the joining position.

Optionally, as shown in FIG. 4, the light shading layer 210 is arranged to surround the whole edge of the optical film 200, and covers the whole non-display area. Thus, the surface of the middle frame 100 is covered to a maximum extent, and the prevention capability of light leakage is high.

The light shading layer 210 can be made of material capable of shading light such as an ink, etc. For example, a surface of the non-display area of the optical film 200 can be covered with an ink layer, to form the light shading layer 210. The ink has the advantages of good light shading effect, strong adhesive capacity, and convenient processing.

### Example 2

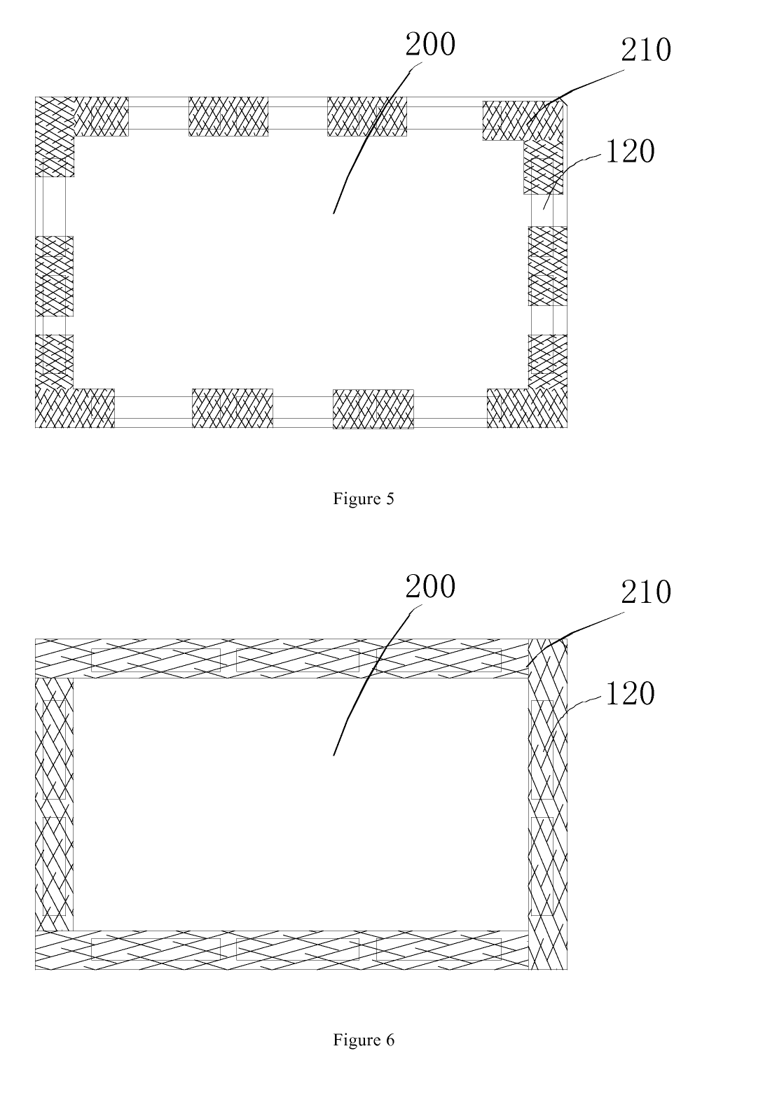

As shown in FIG. 5, an LCD device comprises a middle frame; the middle frame is formed by joining a plurality of frame edge units 120, and a non-display area of an optical film 200 is correspondingly provided with a light shading layer 210 in a joining positions between the middle frame structure units and four corner positions of the middle frame. The optical film 200 can be of a single-layer structure, and can also be of a multiple-layer structure. For the optical film of the multiple-layer structure, only a surface of one of layers is required to be provided with the light shading layer. Because the phenomenon of light leakage in the joining position of the middle frame is the most serious, the cost can be reduced when the light shading layer 210 is purposefully arranged in the joining position.

Optionally, as shown in FIG. 6, the light shading layer 210 is arranged to surround the whole edge of the optical film 200, and covers the whole non-display area. Thus, a surface of the middle frame can be covered to a maximum extent, and the prevention capability of light leakage is high.

The light shading layer 210 can be made of material capable of shading light such as an ink, etc. For example, a surface of the non-display area of the optical film 200 can be covered with an ink layer, to form the light shading layer 210. The ink has the advantages of good light shading effect, strong adhesive capacity, and convenient processing.

The invention is described in detail in accordance with the above contents with the specific preferred examples. However, this invention is not limited to the specific examples. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. An optical film for an LCD device, comprising: a display area in a middle part and a non-display area in an edge part; wherein said non-display area is provided with a light shading layer; said light shading layer is arranged in a joining position of a middle frame for said LCD device; or said light shading layer is arranged to surround said edge part of said optical film, and covers all said non-display area; said optical film comprises a plurality of layers, a surface of said non-display area of one of layers is provided with said light shading layer; said surface of said non-display area of said optical film is covered with an ink layer, to form said light shading layer.

2. An optical film for an LCD device, comprising: a display area in a middle part and a non-display area in an edge part; wherein said non-display area is provided with a light shading layer.

3. The optical film for an LCD device of claim 2, wherein a surface of said non-display area of said optical film is covered with an ink layer, to form said light shading layer.

4. The optical film for an LCD device of claim 2, wherein said light shading layer is arranged in a joining position of a middle frame of said LCD device.

5. The optical film for an LCD device of claim 4, wherein a surface of said non-display area of said optical film is covered with an ink layer, to form said light shading layer.

6. The optical film for an LCD device of claim 2, wherein said light shading layer is arranged to surround said edge part of said optical film, and covers all said non-display area.

7. The optical film for an LCD device of claim 6, wherein a surface of said non-display area of said optical film is covered with an ink layer, to form said light shading layer.

8. The optical film for an LCD device of claim 2, wherein said optical film comprises a plurality of layers; a surface of said non-display area of one of layers is provided with said light shading layer.

9. The optical film for an LCD device of claim 8, wherein said surface of said non-display area of said optical film is covered with an ink layer, to form said light shading layer.

10. An LCD device, comprising: an optical film; wherein said optical film comprises a display area in a middle part and a non-display area in an edge part; said non-display area is provided with a light shading layer in a light leakage position of said LCD device.

11. The LCD device of claim 10, wherein a surface of said non-display area of said optical film is covered with an ink layer, to form said light shading layer.

12. The LCD device of claim 11, wherein said LCD device further comprises a middle frame; a surface of said middle frame is covered with said optical film; said middle frame is formed by joining a plurality of middle frame structure units, and said light shading layer is at least arranged in a joining position of said middle frame structure units of said non-display area of said optical film.

13. The LCD device of claim 12, wherein said surface of said non-display area of said optical film is covered with said ink layer, to form said light shading layer.

14. The LCD device of claim 12, wherein said middle frame is formed by joining a plurality of frame edge units and four frame corner units, and said non-display area of said optical film is provided with said light shading layer in said joining position of said middle frame structure units.

15. The LCD device of claim 14, wherein said surface of said non-display area of said optical film is covered with said ink layer, to form said light shading layer.

16. The LCD device of claim 12, wherein said middle frame is formed by joining a plurality of frame edge units, said non-display area of said optical film is correspondingly provided said light shading layer in said joining positions between said middle frame structure units and four corner positions of said middle frame.

17. The LCD device of claim 16, wherein said surface of said non-display area of said optical film is covered with said ink layer, to form said light shading layer.

18. The LCD device of claim 12, wherein said light shading layer is arranged to surround said edge part of said optical film, and covers all said non-display area.

19. The LCD device of claim 18, wherein said surface of said non-display area of said optical film is covered with said ink layer, to form said light shading layer.
